(19) United States
(12) Patent Application Publication
(10) Pub. No.: US 2007/0290181 A1
(43) Pub. Date: Dec. 20, 2007

(54) Method and apparatus for lifting fifth wheel trailer hitch into a pickup truck

(76) Inventor: William Clinton Bell, Calgary (CA)

Correspondence Address: G. F. Gallinger, 7420 Milner Dr., Colorado Springs, CO, 80920, US

(21) Appl. No.: 11/404,994

(22) Filed: Apr. 17, 2006

(51) Int. Cl. B66C 23/44

(52) U.S. Cl. 254/323; 414/543; 212/180

(57) ABSTRACT

A method of lifting a fifth wheel hitch onto the bed of a pickup truck having a rail pocket in a rear corner portion of its bed sidewall, comprising the steps of: a) providing a mounting post for a crane having a lower portion adapted to be closely received within the rail pocket and an upper crane reception portion extending above the bed sidewall; b) providing a crane having i) a mast having a lower portion adapted to slidingly and rotatably receive the upper crane reception portion of the mounting post therein, and an upper portion extending above the sidewall of the bed; ii) a boom having a rope carrying end portion, and, iii) a rope having one end portion wound on a winch carried by the mast, and an opposite end portion configured to lift an attachment means; c) positioning the post within the rail pocket; d) mating the crane on the post; e) attaching the hitch to the lift attachment means; f) lifting the hitch above the truck bed; g) rotating the mast on the mounting post to thereby swing and position the elevated crane over the truck bed; and finally, h) lowering the positioned hitch onto the truck bed.

### FIELD OF THE INVENTION

This invention relates to heavy lifting and loading into a pickup truck. More particularly this invention relates to a lifting and loading a fifth wheel trailer hitch into a pickup truck with a crane removably seated within a rail pocket provided in a rear corner of the sidewall of the pickup truck.

### BACKGROUND OF THE INVENTION

Lifting a fifth wheel trailer hitch onto the bed of a pickup is a challenging task for two men. The hitch, typically exceeding 200 pounds, generally must be lifted up three feet above the ground. Statistics show that the average age of a fifth wheel user is 57 years. Such a lift may be unhealthy for many men using fifth wheel hitches. And even if the user is able to safely lift one side of the hitch, co-ordinating assistance with a younger male friend at the home of the hitch user is a nuisance. When the hitch is mounted in position on the truck bed the bed is largely unusable. Most individuals prefer to haul the hitch only when they are hauling a trailer. They prefer to mount the hitch just before they haul the trailer, and immediately remove the hitch after they are finished hauling their trailer. A method enabling the user to independently lift and mount the hitch is desired by most users.

### OBJECTS OF THE INVENTION

It is an object of this invention to disclose a method enabling a fifth wheel user to independently mount or remove a fifth wheel hitch from a pick up bed. It is an object of this invention to disclose a method which facilitates mounting or removing a fifth wheel hitch from a pickup without requiring the user to even lift the substantial weight of one side of the hitch. It is yet a further object of this invention to disclose a safe method of mounting and removing a fifth wheel hitch from a pickup truck. It is a final object of this invention to disclose a lightweight, compact hitch which can be carried and conveniently positioned for use within a few minutes.

One aspect of this invention provides for a method of lifting a fifth wheel hitch positioned behind the bed of a pickup truck having a rail pocket in a rear corner portion of its bed sidewall, comprising the steps of: a) providing a mounting post for a crane having a lower portion adapted to be closely received within the rail pocket and an upper crane reception portion extending above the bed sidewall; b) providing a crane having i) a mast having a lower portion adapted to slidingly and rotatably receive the upper crane reception portion of the mounting post therein, and an upper portion extending above the sidewall of the bed; ii) a boom having a rope carrying end portion extending to a lateral central portion of the truck bed, and, iii) a rope having one end portion wound on a winch carried by the mast, and an opposite end portion configured to lift an attachment means to attach to and thereby lift the fifth wheel hitch when the rope is retracted; c) positioning the post within the rail pocket; d) mating the crane on the post; e) attaching the hitch to the lift attachment means; f) retracting the rope to lift the hitch above the truck bed; g) rotating the mast on the mounting post to thereby swing and position the elevated crane over the truck bed; and finally, h) lowering the positioned hitch onto the truck bed.

An apparatus for lifting a load positioned behind the bed of a pickup truck having a rail pocket in a rear corner portion of its bed sidewall, comprises: a) a mounting post for a crane having a lower portion adapted to be closely received within the rail pocket and an upper crane reception portion extending above the bed sidewall; and, b) a crane having i) a mast having a lower portion adapted to slidingly receive the upper crane reception portion of the mounting post therein, so that when the mast is mated with the crane reception portion it is rotatable thereon; ii) a boom having a rope carrying end portion extending to a lateral central portion of the truck bed, and, iii) a rope having one end portion wound on a winch carried by the mast, and an opposite end portion configured to lift a hook when the rope is retracted. When the post is positioned within the rail pocket and the crane is mated on the post, then the load attached to the hook can be lifted above, and thereafter swung over the truck bed.

Various other objects, advantages and features of this invention will become apparent to those skilled in the art from the following description in conjunction with the accompanying drawings.

### FIGURES OF THE INVENTION

FIG. 1 is a perspective view of a rear side portion of a pickup truck having a crane removably seated within a rail pocket provided in a rear corner of the sidewall of the pickup truck. The crane is lifting a fifth wheel trailer hitch seated behind the truck.

FIG. 2 is a perspective view of the rotatable mounting post of the crane removed from the rail pocket in the rear corner of the sidewall of the pickup truck.

The following is a discussion and description of the preferred specific embodiments of this invention, such being made with reference to the drawings, wherein the same reference numerals are used to indicate the same or similar parts and/or structure. It should be noted that such discussion and description is not meant to unduly limit the scope of the invention.

### DESCRIPTION OF THE INVENTION

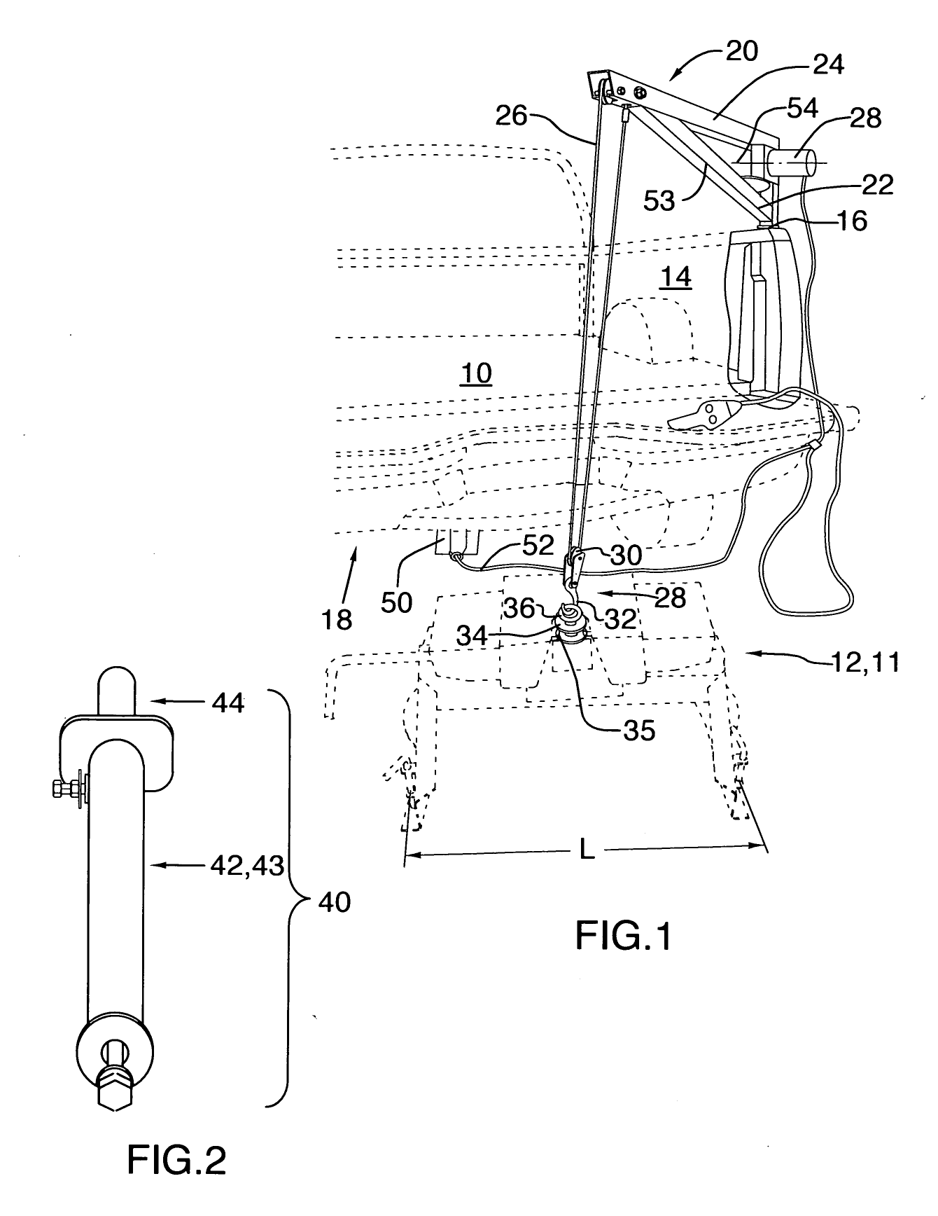

Turning now to the drawings and more particularly to FIG. 1 we have a perspective view of a rear side portion of a pickup truck 18 having a crane 20 removably seated within a rail pocket 16 provided in a rear corner of the bed sidewall 14 of the pickup truck 18. The crane 20 is lifting a fifth wheel trailer hitch 12 seated behind the truck 18. FIG. 2 is a perspective view of a rotatable mounting post 40 of the crane 20 removed from the rail pocket 16 in the rear corner of the sidewall 14 of the pickup truck 18. Most generally, a method of lifting a fifth wheel hitch 12 positioned behind the bed 10 of a pickup truck 18 having a rail pocket 16 in a rear corner portion of its bed sidewall 14, comprising the steps of: a) providing a rotatable mounting post 40 for the crane 20 having a lower portion 42 adapted to be closely received within the rail pocket 16 and an upper crane reception portion 44 extending above the bed sidewall 16; b) providing the crane 20 having i) a mast 22 having a lower portion adapted to slidingly and rotatably receive the upper crane reception portion 44 of the mounting post 40 therein, and an upper portion extending above the sidewall 14 of the bed 10; ii) a boom 24 having a rope carrying end portion extending to a lateral central portion of the truck bed 10, and, iii) a rope 26 having one end portion wound on a winch 28 carried by the mast 22, and an opposite end portion configured to lift an attachment means 28 to attach to and thereby lift the fifth wheel hitch 12 when the rope 26 is retracted; c) positioning the post 40 within the rail pocket 16; d) mating the crane 20 on the post 40; e) attaching the hitch 12 to the lift attachment means 28; f) retracting the rope 26 to lift the hitch 12 above the truck bed 10; g) rotating the mast 22 on the mounting post 40 to thereby swing and position the elevated crane 20 over the truck bed 10; and finally, h) lowering the positioned hitch 12 onto the truck bed 10.

Most preferably the attachment means 28 comprises an upright spool 34 having a central portion dimensioned to be received within a throat 35 of the hitch 12 thereby facilitating quick, balanced, and rotatable attachment to the hitch without additional encircling rigging (not shown). Most preferably the method further comprises the step of rotating the hitch 12 about a vertical portion of the rope 26, after the hitch is elevated so that its lateral length L is aligned with the length of the truck bed 10, thereby easing transition of the hitch 12 over and into the truck bed 10. In the most preferred embodiment of the invention the attachment means 28 further comprises a hook 32 to facilitate lifting other than the hitch 12 and wherein a top portion of the spool 34 further comprises an upright loop 36 to receive the hook 32.

Most preferably the mounting post 40 has a lower portion 42 which comprises a reinforcing pocket insert 43 having a bottom portion which is anchored through the bed 10 of the truck 18 thereunder, thereby increasing the structural strength of the sheet metal rail pocket 16 a multiple of times so that it can withstand a twisting moment produced by the crane 20. When the rail pocket 16 is structurally reinforced from within, rather than from without, said substantial structural reinforcement is almost wholly inconspicuous when the truck 18 is viewed. In the most preferred embodiment of the invention, the upper crane reception portion 44 of the mounting post 40 is designed so that the upper reception portion 44 thereof can be lifted up and out of the reinforcing pocket insert 43 when the crane 20 is not in use, then the mounting post 40 is still convenient to use and thereby largely inconspicuous when not in use.

When the pickup truck 18 has a trailer power receptacle 50 and wherein the winch 28 is electrically powered and has a power cord 52 adapted to plug into the trailer power receptacle 50. Also in the most preferred embodiment of the invention the winch 28 is lockably, releasably, and rotatably mounted beneath the boom 24 of the crane 20 and wherein when released the winch 28 can be rotated from a working position to a storage position wherein its longitudinal axis 54 is generally aligned with the boom 24 to facilitate compact storage thereof.

If an end portion of the opposite end portion of the rope 26 is attached to the boom 24, and if the lift attachment means 28 comprises a pulley 30 carrying a hook 32, and if said pulley 30 is carried by the opposite end portion of the rope 26 then the rope tension is halved and the lifting power of the winch 28 is doubled. Most preferably the crane 20 further comprises a support member 23 obliquely extending between a central portion of the boom 24 and a central portion of the upper portion of the crane mast 22 extending above the bed sidewall 14, and wherein the winch 28 is carried by and above the support member 23.

When the crane comprises two inch square tubing which is lightweight structural aircraft aluminum (such as T65 11) then the overall weight of the crane 20 can be reduced from approximately 67 to 27 pounds. This facilitates easy and convenient removal from storage and positioning on the truck 18.

An apparatus for lifting a load 11 positioned behind the bed 10 of a pickup truck 18 having a rail pocket 16 in a rear corner portion of its bed sidewall 14, comprises: a) a mounting post 40 for a crane 20 having a lower portion 42 adapted to be closely received within the rail pocket 16 and an upper crane reception portion 44 extending above the bed sidewall 14; and, b) a crane 20 having i) a mast 22 having a lower portion adapted to slidingly receive the upper crane reception portion 44 of the mounting post 40 therein, so that when the mast 22 is mated with the crane reception portion 44 it is rotatable thereon; ii) a boom 24 having a rope carrying end portion extending to a lateral central portion of the truck bed 10, and, iii) a rope 26 having one end portion wound on a winch 28 carried by the mast 24, and an opposite end portion configured to lift a hook 32 when the rope 26 is retracted. When the post 40 is positioned within the rail pocket 16 and the crane 20 is mated on the post 40, then the load 11 attached to the hook 32 can be lifted above, and thereafter swung over the truck bed 10.

While the invention has been described with preferred specific embodiments thereof, it will be understood that this description is intended to illustrate and not to limit the scope of the invention, which is defined by the following claims.

I claim:

1) A method of lifting a fifth wheel hitch positioned behind the bed of a pickup truck having a rail pocket in a rear corner portion of its bed sidewall, comprising the steps of:
a) providing a mounting post for a crane having a lower portion adapted to be closely received within the rail pocket and an upper crane reception portion extending above the bed sidewall;
b) providing a crane having i) a mast having a lower portion adapted to slidingly and rotatably receive the upper crane reception portion of the mounting post therein, and an upper portion extending above the sidewall of the bed; ii) a boom having a rope carrying end portion extending to a lateral central portion of the truck bed, and, iii) a rope having one end portion wound on a winch carried by the mast, and an opposite end portion configured to lift an attachment means to attach to and thereby lift the fifth wheel hitch when the rope is retracted;
c) positioning the post within the rail pocket;
d) mating the crane on the post;
e) attaching the hitch to the lift attachment means;
f) retracting the rope to lift the hitch above the truck bed;
g) rotating the mast on the mounting post to thereby swing and position the elevated crane over the truck bed; and finally,
h) lowering the positioned hitch onto the truck bed.

2) A method as in claim 1 wherein the attachment means comprises an upright spool having a central portion dimensioned to be received within a throat of the hitch thereby facilitating quick, balanced, and rotatable attachment to the hitch without additional encircling rigging.

3) A method as in claim 2 further comprising the step of rotating the hitch about a vertical portion of the rope, after the hitch is elevated so that its lateral length is aligned with the length of the truck bed, thereby easing transition of the hitch over and into the truck bed.

4) A method as in claim 2 wherein the attachment means further comprises a hook to facilitate lifting other than the hitch and wherein a top portion of the spool further comprises an upright loop to receive the hook.

5) A method as in claim 1 wherein the mounting post has a lower portion which comprises a reinforcing pocket insert having a bottom portion which is anchored through the bed of the truck thereunder, thereby increasing the structural strength of the sheet metal rail pocket a multiple of times so that it can withstand a twisting moment produced by the crane, and wherein when the rail pocket is structurally reinforced within, rather than without, said substantial structural reinforcement is almost wholly inconspicuous.

6) A method as in claim 5 wherein the upper crane reception portion of the mounting post may be lifted up and out of the reinforcing pocket insert when the crane is not in use, so that the crane may then be subsequently used merely by reinserting the upper crane reception portion down into the reinforcing pocket insert, and so that the mounting post is largely inconspicuous when said upper crane reception portion is not in use and removed therefrom.

7) A method as in claim 1 wherein the pickup truck has a trailer power receptacle and wherein the winch is electrically powered and has a power cord adapted to plug into the trailer power receptacle.

8) A method as in claim 7 wherein the winch is lockably, releasably, and rotatably mounted beneath the boom of the crane and wherein when released the winch can be rotated from a working position to a storage position wherein its longitudinal axis is generally aligned with the boom to facilitate compact storage thereof.

9) A method as in claim 1 wherein an end portion of the opposite end portion of the rope is attached to the boom, and wherein the lift attachment means comprises a pulley carrying a hook, and wherein said pulley is carried by the opposite end portion of the rope then rope tension is halved and lifting power of the winch is doubled.
then if said pulley 30 is carried by the opposite end portion of the rope 26 then the rope tension is halved and the lifting power of the winch is doubled.

10) A method as in claim 1 wherein the crane further comprises a support member obliquely extending between a central portion of the boom and a central portion of the upper portion of the crane mast extending above the bed sidewall, and wherein the winch is carried by and above the support member.

11) A method as in claim 10 wherein the crane comprises lightweight structural aircraft aluminum.

12) A method as in claim 10 wherein the crane comprises two inch square tubing.

13) An apparatus for lifting a load positioned behind the bed of a pickup truck having a rail pocket in a rear corner portion of its bed sidewall, comprising:
a) a mounting post for a crane having a lower portion adapted to be closely received within the rail pocket and an upper crane reception portion extending above the bed sidewall; and,
b) a crane having i) a mast having a lower portion adapted to slidingly receive the upper crane reception portion of the mounting post therein, so that when the mast is mated with the crane reception portion it is rotatable thereon; ii) a boom having a rope carrying end portion extending to a lateral central portion of the truck bed, and, iii) a rope having one end portion wound on a winch carried by the mast, and an opposite end portion configured to lift a hook when the rope is retracted;
so that when the post is positioned within the rail pocket and the crane is mated on the post, then the load attached to the hook can be lifted above, and thereafter swung over the truck bed.

14) A method as in claim 13 wherein the pickup truck has a trailer power receptacle and wherein the winch is electrically powered and has a power cord adapted to plug into the trailer power receptacle.

15) A method as in claim 14 wherein the winch is lockably, releasably, and rotatably mounted beneath the boom of the crane and wherein when released the winch can be rotated from a working position to a storage position wherein its longitudinal axis is generally aligned with the mast of the boom to facilitate compact storage thereof.

16) A method as in claim 13 wherein an end portion of the opposite end portion of the rope is attached to the rope carrying end portion of the boom, and wherein the lift attachment means comprises a pulley carrying a hook, said pulley looped within the opposite end portion of the rope to thereby halve the rope tension and double the lifting power of the winch.

17) A method as in claim 13 wherein the crane further comprises a support member obliquely extending between a central portion of the boom and a central portion of the upper portion of the crane mast extending above the bed sidewall, and wherein the winch is carried above the support member.

18) A method as in claim 17 wherein the crane comprises lightweight structural aircraft aluminum.

19) A method as in claim 18 wherein the crane comprises two inch square tubing.
